(19) United States
(12) Patent Application Publication
(10) Pub. No.: US 2004/0098753 A1
(43) Pub. Date: May 20, 2004

(54) Video combiner

(76) Inventors: Steven Reynolds, Littleton, CO (US); Thomas Lemmons, Evergreen, CO (US)

Correspondence Address: The Law Offices of William W. Cochran, LLC, Suite 230, 3555 Stanford Road, Fort Collins, CO, 80525, US

(21) Appl. No.: 10/609,000

(22) Filed: Jun. 26, 2003

Related U.S. Application Data
(63) Continuation-in-part of application No. 10/103,545, filed on Mar. 20, 2002.

(51) Int. Cl. H04N 7/173; H04N 7/00; H04N 11/00; H04N 7/16

(52) U.S. Cl. 725/135; 725/113; 348/461; 348/468

(57) ABSTRACT

Disclosed is a system that digitally decodes and combines portions of two or more broadcast video signals in a memory of a set top box in a manner described by a presentation description. The presentation description may be transferred as part of a broadcast video signal or may be accessed across a network. Different presentation descriptions may be sent to different set top boxes depending on set top box type or user preferences. The presentation description may be modified by user input or by stored user preferences. Audio and/or image portions of the video signals may be combined to produce a combined video output. Combination methods include replacement, logical and mathematical operations or a combination thereof. The presentation description may include dynamic variables that specify the manner of combination for a plurality of frames or a specified period of display.

### CROSS REFERENCE TO RELATED APPLICATIONS

This application is continuation-in-part of U.S. non-provisional application Ser. No. 10/103,545 entitled “VIDEO COMBINER” filed Mar. 20, 2002 by Steve Reynolds and Tom Lemmons and is based upon U.S. provisional application No. 60/278,669 entitled “DELIVERY OF INTERACTIVE VIDEO CONTENT USING FULL MOTION VIDEO PLANES” filed Mar. 20, 2001 by Steve Reynolds and Tom Lemmons. The entire disclosure of both applications are specifically incorporated herein by reference for all that they disclose and teach.

### BACKGROUND OF THE INVENTION

a. Field of the Invention

The present invention pertains generally to the generation of video signals and specifically to the generation of combined video signals.

b. Description of the Background

The process of combining video signals has been used in the past to generate unique combined video signals. For example, combined video signals have been used to combine foreground and background material in various ways, as well as other types of materials. Typically, this process is performed during production, such as in a production studio. The combined video signal generates a correlated image wherein the parts of the individual video signals are interrelated and used to create a unified, single picture, rather than two separate pictures that are displayed either simultaneously or separately.

There are many uses for combined or correlated video signals. For example, various combinations of individual video signals can be generated for viewing by different demographic groups to match the preferences of each group. In that regard, an automobile manufacturer may want to run a national advertisement. In the mountain states, it may be desirable to have depictions of mountains or skiing in the background. When the same advertisement is run in Florida, it may be preferable to have depictions of beaches and surf in the background. The demographics may be even more refined. For example, the preferences may vary on a viewer-by-viewer basis. However, for each combination, a separate combined video signal must be generated.

Combined video signals have other applications. It may be desirable to combine various interactive video feeds to produce a desired combined or correlated video signal for a particular viewer. Other applications of combined video signals include interactive games that can be combined as overlays with standard video feeds, advertising that can be combined with standard video feeds, or enhanced video feeds that can be combined in various fashions.

The problem that has existed in providing these combined video signals is that separate combined signals must be produced, usually at a studio production level. Each combined video signal must then be separately transmitted to the appropriate viewer. If there are a large number of different video feeds that are desired to be combined, this requires an exponentially larger number of combined video signals. For example, as the number of video feeds that are desired to be combined in various ways increases in a linear fashion, the number of combined video signals exponentially increases. The transmission channels for transmitting a large number of combined video signals may not be available, or may be very expensive to provide and maintain.

### SUMMARY OF THE INVENTION

The present invention overcomes the disadvantages and limitations of the prior art by providing a system that is capable of combining video signals at the viewer's location. For example, multiple video feeds can be provided to a viewer's set-top box together with instructions for combining two or more video feeds. The video feeds can then be combined in a set-top box or otherwise located at or near the viewer's location to generate the combined or correlated video signal for display. Additionally, one or more video feeds can comprise enhanced video that is provided from an Internet connection. HTML-like scripting can be used to indicate the layout of the enhanced video signal. Instructions can be provided for replacement of individual pixels on a pixel-by-pixel basis. Further, presentation descriptions can be provided for combining HTML-like generated depictions with video signals.

The present invention may therefore comprise a method of producing a video signal at a set top box comprising: receiving a first video signal at the set top box; processing the first video signal to produce a first image stored in memory of the set top box; receiving a second video signal at the set top box; processing the second video signal to produce a second image stored in the memory of the set top box; accessing a presentation description that defines a portion of the first image and that defines the manner in which the portion of the first image and a portion of the second image are combined; combining the portion of the first image with the portion of the second image in accordance with the presentation description to produce a combined image; and displaying the combined image.

The present invention may further comprise a method of displaying a sequence of combined images in a set top box comprising: receiving a first video signal at the set top box; processing the first video signal to produce a first sequence of images stored in memory of the set top box; receiving a second video signal at the set top box; processing the second video signal to produce a second sequence of images stored in the memory of the set top box; accessing a presentation description that defines a portion of the first sequence of images and that defines the manner in which the portion of the first sequence of images and a portion of the second sequence of images are combined; combining the portion of the first sequence of images with the portion of the second sequence of images in accordance with the presentation description to produce a sequence of combined images; and displaying the sequence of combined images.

The present invention may further comprise a method of controlling generation of a combined video signal in a set top box unit at a user's premises from a broadcast site comprising: transmitting a first digital video signal to the set top box; transmitting a second digital video signal to the set top box substantially simultaneously with the first digital video signal; loading image combination code into the set top box; and providing a presentation description to the set top box that describes the manner in which a portion of an image contained in the first digital video signal is combined with a portion of an image contained in the second digital video signal to produce the combined video signal.

The present invention may further comprise a set top box that produces a combined video signal comprising: a processor; a memory; a tuner/decoder that receives a first video signal and a second video signal substantially simultaneously and that routes control information contained in the first video signal to the processor and that routes first video data from the first video signal and second video data from the second video signal to a decoder; said decoder that decodes the first video data and produces a first video image in the memory and that decodes the second video data and produces a second video image in the memory; a presentation description stored in the memory that specifies the manner in which a portion of the first video image is combined with a portion of the second video image to produce the combined signal; program code operating in the processor that employs the presentation description and that accesses the portion of first video image and the portion of the second video image in the memory and that combines the first portion of the first video image and the portion of the second video image in a manner specified by the presentation description; and a video output unit that outputs the combined signal to a display device.

The advantages of the present invention are that combined video signals can be generated at a viewer location upon receipt of individual video feeds and instructions for combining the video signals. In this fashion, the individual video feeds only need to be transmitted rather than each of the combined video signals. This decreases the bandwidth of the transmission link for transmitting the data since the individual video feeds are transmitted and combined in various ways at the viewer's location.

### BRIEF DESCRIPTION OF THE DRAWINGS

In the drawings,

FIG. 1 is a schematic illustration of the overall system of the present invention;

FIG. 2 is a detailed block diagram of a set-top box, display, and remote control device of the system of the present invention.

FIG. 3 is an illustration of an embodiment of the present invention wherein four video signals may be combined into four composite video signals.

FIG. 4 is an illustration of an embodiment of the present invention wherein a main video image is combined with portions of a second video image to create five composite video signals.

FIG. 5 depicts another set top box embodiment of the present invention.

FIG. 6 depicts a sequence of steps employed to create a combined image at a user's set top box.

### DETAILED DESCRIPTION OF THE PREFERRED EMBODIMENT OF THE INVENTION

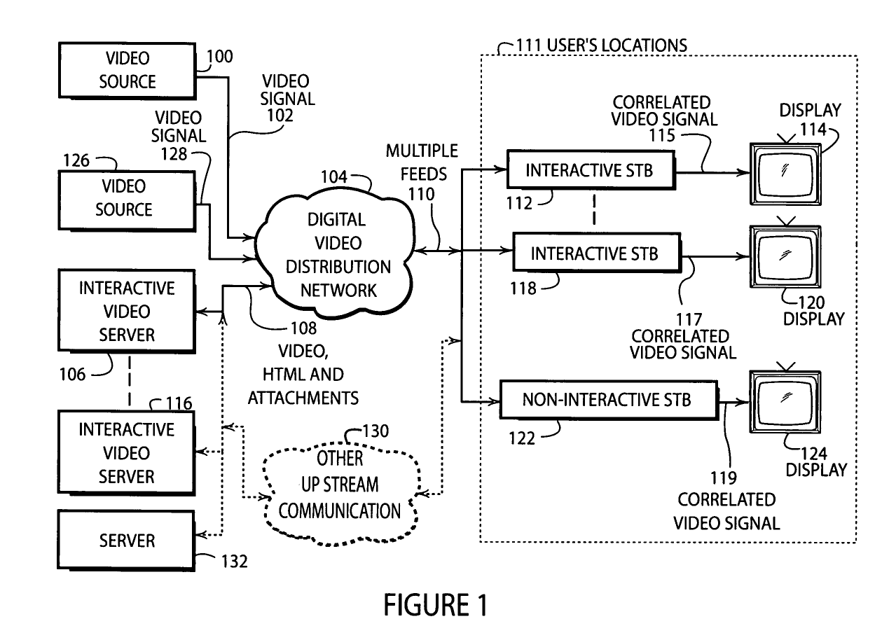

FIG. 1 illustrates the interconnections of the various components that may be used to deliver a composite video signal to individual viewers. Video sources 100 and 126 send video signals 102 and 126 through a distribution network 104 to viewer's locations 111. Additionally, multiple interactive video servers 106 and 116 send video, HTML, and other attachments 108. The multiple feeds 110 are sent to several set top boxes 112, 118, and 122 connected to televisions 114, 120, and 124, respectively. The set top boxes 112 and 118 may be interactive set top boxes and set top box 122 may not have interactive features.

The video sources 100 and 126 and interactive video servers 106 and 116 may be attached to a conventional cable television head-end, a satellite distribution center, or other centralized distribution point for video signals. The distribution network 104 may comprise a cable television network, satellite television network, Internet video distribution network, or any other network capable of distributing video data.

The interactive set top boxes 112 and 118 may communicate to the interactive video servers 106 and 108 though the video distribution network 104 if the video distribution network supports two-way communication, such as with cable modems. Additionally, communication may be through other upstream communication networks 130. Such upstream networks may include a dial up modem, direct Internet connection, or other communication network that allows communication separate from the video distribution network 104.

Although FIG. 1 illustrates the use of interactive set-top boxes 112 and 118, the present invention can be implemented without an interactive connection with an interactive video server, such as interactive video servers 106 and 116. In that case, separate multiple video sources 100 can provide multiple video feeds 110 to non-interactive set-top box 122 at the viewer's locations 111. The difference between the interactive set top boxes 112 and 118 and the non-interactive set top box 122 is that the interactive set top boxes 112 and 118 incorporate the functionality to receive, format, and display interactive content and send interactive requests to the interactive video servers 106 and 116.

The set top boxes 112, 118, and 122 may receive and decode two or more video feeds and combine the feeds to produce a composite video signal that is displayed for the viewer. Such a composite video signal may be different for each viewer, since the video signals may be combined in several different manners. The manner in which the signals are combined is described in the presentation description. The presentation description may be provided through the interactive video servers 106 and 116 or through another server 132. Server 132 may be a web server or a specialized data server.

As disclosed below, the set-top box includes multiple video decoders and a video controller that provides control signals for combining the video signal that is displayed on the display 114. In accordance with currently available technology, the interactive set-top box 112 can provide requests to the interactive video server 106 to provide various web connections for display on the display 114. Multiple interactive video servers 116 can provide multiple signals to the viewer's locations 111.

The set top boxes 112, 118, and 122 may be a separate box that physically rests on top of a viewer's television set, may be incorporated into the television electronics, may be functions performed by a programmable computer, or may take on any other form. As such, a set top box refers to any receiving apparatus capable of receiving video signals and employing a presentation description as disclosed herein.

The manner in which the video signals are to be combined is defined in the presentation description. The presentation description may be a separate file provided by the server 132, the interactive video servers 106 and 116, or may be embedded into one or more of the multiple feeds 110. A plurality of presentation descriptions may be transmitted and program code operating in a set top box may select one or more of the presentation descriptions based upon an identifier in the presentation description(s). This allows presentation descriptions to be selected that correspond to set top box requirements and/or viewer preferences or other information. Further, demographic information may be employed by upstream equipment to determine a presentation description version for a specific set top box or group of set top boxes and an identifier of the presentation description version(s) may then be sent to the set top box or boxes. Presentation descriptions may also be accessed across a network, such as the Internet, that may employ upstream communication on a cable system or other networks. In a similar manner, a set top box may access a presentation description across a network that corresponds to set top box requirements and/or viewer preferences or other information. And in a similar manner as described above, demographic information may be employed by upstream equipment to determine a presentation description version for a specific set top box or group of set top boxes and an identifier of the presentation description version(s) may then be sent to the set top box or boxes. The identifier may comprise a URL, filename, extension or other information that identifies the presentation description. Further, a plurality of presentation descriptions may be transferred to a set top box and a viewer may select versions of the presentation description. Alternatively, software program operating in the set top box may generate the presentation description and such generation may also employ viewer preferences or demographic information.

In some cases, the presentation description may be provided by the viewer directly into the set top box 112, 118, 122, or may be modified by the viewer. Such a presentation description may be viewer preferences stored in the set top box and created using menus, buttons on a remote, a graphical viewer interface, or any combination of the above. Other methods of creating a local presentation description may also be used.

The presentation description may take the form of a markup language wherein the format, look and feel of a video image is controlled. Using such a language, the manner in which two or more video images are combined may be fully defined. The language may be similar to XML, HTML or other graphical mark-up languages and allow certain video functions such as pixel by pixel replacement, rotation, translation, and deforming of portions of video images, the creation of text and other graphical elements, overlaying and ghosting of one video image with another, color key replacement of one video image with another, and any other command as may be contemplated. In contrast to hard-coded image placement choices typical to picture-in-picture (PIP) display, the presentation description of the present invention is a “soft” description that provides freedom in the manner in which images are combined and that may be easily created, changed, modified or updated. The presentation is not limited to any specific format and may employ private or public formats or a combination thereof. Further, the presentation description may comprise a sequence of operations to be performed over a period of time or over a number of frames. In other words, the presentation description may be dynamic. For example, a video image that is combined with another video image may move across the screen, fade in or out, may be altered in perspective from frame to frame, or may change in size.

Specific presentation descriptions may be created for each set top box and tailored to each viewer. A general presentation description suited to a plurality of set top boxes may be parsed, translated, interpreted, or otherwise altered to conform to the requirements of a specific set top box and/or to be tailored to correspond to a viewer demographic, preference, or other information. For example, advertisements may be targeted at selected groups of viewers or a viewer may have preferences for certain look and feel of a television program. In some instances, some presentation descriptions may be applied to large groups of viewers.

The presentation descriptions may be transmitted from a server 132 to each set top box through a backchannel 130 or other network connection, or may be embedded into one or more of the video signals sent to the set top box. Further, the presentation descriptions may be sent individually to each set top box based on the address of the specific set top box. Alternatively, a plurality of presentation descriptions may be transmitted and a set top box may select and store one of the presentation descriptions based upon an identifier or other information contained in the presentation description. In some instances, the set top box may request a presentation description through the backchannel 130 or through the video distribution network 104. At that point, a server 132, interactive video server 106 or 116, or other source for a presentation description may send the requested presentation description to the set top box.

Interactive content supplied by interactive video server 106 or 116 may include the instructions for a set top box to request the presentation description from a server through a backchannel. A methodology for transmitting and receiving this data is described in US Provisional Patent Application entitled “Multicasting of Interactive Data Over A Back Channel”, filed Mar. 5, 2002 by Ian Zenoni, which is specifically incorporated herein by reference for all it discloses and teaches.

The presentation description may contain the commands necessary for several combinations of video. In such a case, the local preferences of the viewer, stored in the set top box, may indicate which set of commands would be used to display the specific combination of video suitable for that viewer. For example, in an advertisement campaign, a presentation description may include commands for combining several video images for four different commercials for four different products. The viewer's preferences located inside the set top box may indicate a preference for the first commercial, thusly the commands required to combine the video signals to produce the first commercial will be executed and the other three sets of commands will be ignored.

In operation, the device of FIG. 1 provides multiple video feeds 110 to the viewer's locations 111. The multiple video feeds are combined by each of the interactive set-top boxes 112, 118, 122 to generate correlated or composite video signals 115, 117, 119, respectively. As disclosed below, each of the interactive set-top boxes 112, 118, 122 uses instructions provided by the video source 100, interactive video servers 106, 116, a separate server 132, or viewer preferences stored at the viewer's location to generate control signals to combine the signals into a correlated video signal. Additionally, presentation description information provided by each of the interactive video servers 106, 116 can provide layout descriptions for displaying a video attachment. The correlated video signal may overlay the various video feeds on a full screen basis, or on portions of the screen display. In any event, the various video feeds may interrelate to each other in some fashion such that the displayed signal is a correlated video signal with interrelated parts provided by each of the separate video feeds.

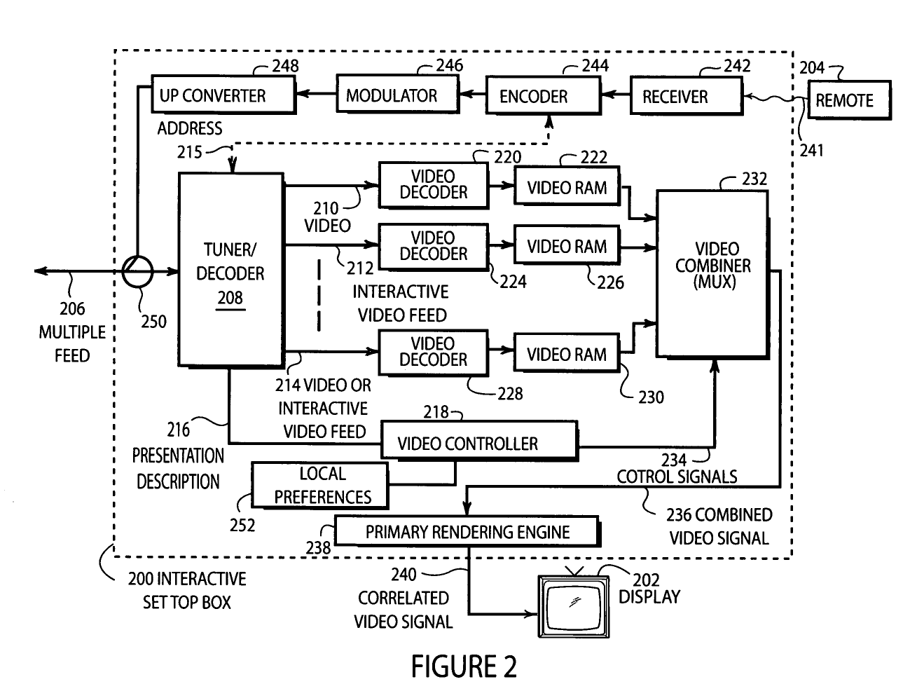

FIG. 2 is a detailed schematic block diagram of an interactive set-top box together with a display 202 and remote control device 204. As shown in FIG. 2, a multiple video feed signal 206 is supplied to the interactive set-top box 200. The multiple video feed signal 206 that includes a video signal, HTML signals, video attachments, a presentation description, and other information is applied to a tuner/decoder 208. The tuner/decoder 208 extracts each of the different signals such as a video MPEG signal 210, an interactive video feed 212, another video or interactive video feed 214, and the presentation description information 216.

The presentation description information 216 is the information necessary for the video combiner 232 to combine the various portions of multiple video signals to form a composite video image. The presentation description information 216 can take many forms, such as an ATVEF trigger or a markup language description using HTML or a similar format. Such information may be transmitted in a vertical blanking encoded signal that includes instructions as to the manner in which to combine the various video signals. For example, the presentation description may be encoded in the vertical blanking interval (VBI) of stream 210. The presentation description may also include Internet addresses for connecting to enhanced video web sites. The presentation description information 216 may include specialized commands applicable to specialized set top boxes, or may contain generic commands that are applicable to a wide range of set top boxes. References made herein to the ATVEF specification are made for illustrative purposes only, and such references should not be construed as an endorsement, in any manner, of the ATVEF specification.

The presentation description information 216 may be a program that is embedded into one or more of the video signals in the multiple feed 206. In some cases, the presentation description information 216 may be sent to the set top box in a separate channel or communication format that is unrelated to the video signals being used to form the composite video image. For example, the presentation description information 216 may come through a direct internet connection made through a cable modem, a dial up internet access, a specialized data channel carried in the multiple feed 206, or any other communication method.

As also shown in FIG. 2, the video signal 210 is applied to a video decoder 220 to decode the video signal and apply the digital video signal to video RAM 222 for temporary storage. The video signal 210 may be in the MPEG standard, wherein predictive and intracoded frames comprise the video signal. Other video standards may be used for the storage and transmission of the video signal 210 while maintaining within the spirit and intent of the present invention. Similarly, video decoder 224 receives the interactive video feed 212 that may comprise a video attachment from an interactive web page. The video decoder 224 decodes the video signal and applies it to a video RAM 226. Video decoder 228 is connected to video RAM 230 and operates in the same fashion. The video decoders 220, 224, 228 may also perform decompression functions to decompress MPEG or other compressed video signals. Each of the video signals from video RAMs 222, 226, 230 is applied to a video combiner 232. Video combiner 232 may comprise a multiplexer or other device for combining the video signals. The video combiner 232 operates under the control of control signals 234 that are generated by the video controller 218. In some embodiments of the present invention, a high-speed video decoder may process more than one video feed and the functions depicted for video decoders 220, 224, 228 and RAMs 222, 226, 230 may be implemented in fewer components. Video combiner 232 may include arithmetic and logical processing functions.

The video controller 218 receives the presentation description instructions 216 and generates the control signals 234 to control the video combiner 232. The control signals may include many commands to merge one video image with another. Such commands may include direct overlay of one image with another, pixel by pixel replacement, color keyed replacement, the translation, rotation, or other movement of a section of video, ghosting of one image over another, or any other manipulation of one image and combination with another as one might desire. For example, the presentation description instructions 216 may indicate that the video signal 210 be displayed on full screen while the interactive video feed 212 only be displayed on the top third portion of the screen.

The presentation description instructions 216 also instruct the video controller 218 as to how to display the pixel information. For example, the control signals 234 generated by the video controller 218 may replace the background video pixels of video 210 in the areas where the interactive video feed 212 is applied on the top portion of the display. The presentation description instructions 216 may set limits as to replacement of pixels based on color, intensity, or other factors. Pixels can also be displayed based upon the combined output of each of the video signals at any particular pixel location to provide a truly combined output signal. Of course, any desired type of combination of the video signals can be obtained, as desired, to produce the combined video signal 236 at the output of the video combiner 232. Also, any number of video signals can be combined by the video combiner 232 as illustrated in FIG. 2. It is only necessary that a presentation description 216 be provided so that the video controller 218 can generate the control signals 234 that instruct the video combiner 232 to properly combine the various video signals.

The presentation description instructions 216 may be instructions sent from a server directly to the set top box 200 or the presentation description instructions 216 may be settable by the viewer. For example, if an advertisement were to be shown to a specific geographical area, such as to the viewers in a certain zip code, a set of presentation description instructions 216 may be embedded into the advertisement video instructing the set top box 200 to combine the video in a certain manner.

In some embodiments, the viewer's preferences may be stored in the local preferences 252 and used either alone or in conjunction with the presentation description instructions 216. For example, the local preferences may be to merge a certain preferred background with a news show. In another example, the viewer's local preferences may select from a list of several options presented in the presentation description information 216. In such an example, the presentation description information 216 may contain the instructions for several alternative presentation schemes, one of which may be preferred by a viewer and contained in the local preferences 252.

In some embodiments, the viewer's preferences may be stored in a central server. Such an embodiment may provide for the collection and analysis of statistics regarding viewer preferences. Further, customized and targeted advertisements and programming preferences may be sent directly to the viewer, based on their preferences analyzed on a central server. The server may have the capacity to download presentation description instructions 216 directly to the viewer's set top box. Such a download may be pushed, wherein the server sends the presentation description instructions 216, or pulled, wherein the set top box requests the presentation description instructions 216 from the server.

As also shown in FIG. 2, the combined video signal 236 is applied to a primary rendering engine 238. The primary rendering engine 238 generates the correlated video signal 240. The primary rendering engine 238 formats the digital combined video signal 236 to produce the correlated video signal 240. If the display 202 is an analog display, the primary rendering engine 238 also performs functions as a digital-to-analog converter. If the display 202 is a high definition digital display, the primary rendering engine 238 places the bits in the proper format in the correlated video signal 240 for display on the digital display.

FIG. 2 also discloses a remote control device 204 under the operation of a viewer. The remote control device 204 operates in the standard fashion in which remote control devices interact with interactive set-top boxes, such as interactive set-top box 200. The set-top box includes a receiver 242 such as an infrared (IR) receiver that receives the signal 241 from the remote 204. The receiver 242 transforms the IR signal into an electrical signal that is applied to an encoder 244. The encoder 244 encodes the signal into the proper format for transmission as an interactive signal over the digital video distribution network 104 (FIG. 1). The signal is modulated by modulator 246 and up-converted by up-converter 248 to the proper frequency. The up-converted signal is then applied to a directional coupler 250 for transmission on the multiple feed 206 to the digital video distribution network 104. Other methods of interacting with an interactive set top box may be also employed. For example, viewer input may come through a keyboard, mouse, joystick, or other pointing or selecting device. Further, other forms of input, including audio and video may be used. The example of the remote control 204 is exemplary and not intended to limit the invention.

As also shown in FIG. 2, the tuner/decoder 208 may detect web address information 215 that may be encoded in the video signal 102 (FIG. 1). This web address information may contain information as to one or more web sites that contain presentation descriptions that interrelates to the video signal 102 and that can be used to provide the correlated video signal 240. The decoder 208 detects the address information 215 which may be encoded in any one of several different ways such as an ATVEF trigger, as a tag in the vertical blanking interval (VBI), encoded in the back channel, embedded as a data PID (packet identifier) signal in a MPEG stream, or other encoding and transmitting method. The information can also be encoded in streaming media in accordance with Microsoft's ASF format. Encoding this information as an indicator is more fully disclosed in U.S. patent application Ser. No. 10/076,950, filed Feb. 12, 2002 entitled “Video Tags and Markers,” which is specifically incorporated herein by reference for all that it discloses and teaches. The manner in which the tuner/decoder 208 can extract the one or more web addresses 215 is more fully disclosed in the above referenced patent application. In any event, the address information 215 is applied to the encoder 244 and is encoded for transmission through the digital video distribution network 104 to an interactive video server. The signal is modulated by modulator 246 and up-converted by up-converter 248 for transmission to the directional coupler 250 over the cable. In this fashion, video feeds can automatically be provided by the video source 100 via the video signal 102.

The web address information that is provided can be selected, as referenced above, by the viewer activating the remote control device 204. The remote control device 204 can comprise a personalized remote, such as disclosed in U.S. patent application Ser. No. 09/941,148, filed Aug. 27, 2001 entitled “Personalized Remote Control,” which is specifically incorporated by reference for all that it discloses and teaches. Additionally, interactivity using the remote 204 can be provided in accordance with U.S. patent application Ser. No. 10/041,881, filed Oct. 24, 2001 entitled “Creating On-Content Enhancements,” which is specifically incorporated herein by reference for all that it discloses and teaches. In other words, the remote 204 can be used to access “hot spots” on any one of the interactive video feeds to provide further interactivity, such as the ability to order products and services, and other uses of the “hot spots” as disclosed in the above referenced patent application. Preference data can also be provided in an automated fashion based upon viewer preferences that have been learned by the system or are selected in a manual fashion using the remote control device in accordance with U.S. patent application Ser. No. 09/933,928, filed Aug. 21, 2001, entitled “iSelect Video” and U.S. patent application Ser. No. 10/080,996, filed Feb. 20, 2002 entitled “Content Based Video Selection,” both of which are specifically incorporated by reference for all that they disclose and teach. In this fashion, automated or manually selected preferences can be provided to generate the correlated video signal 240.

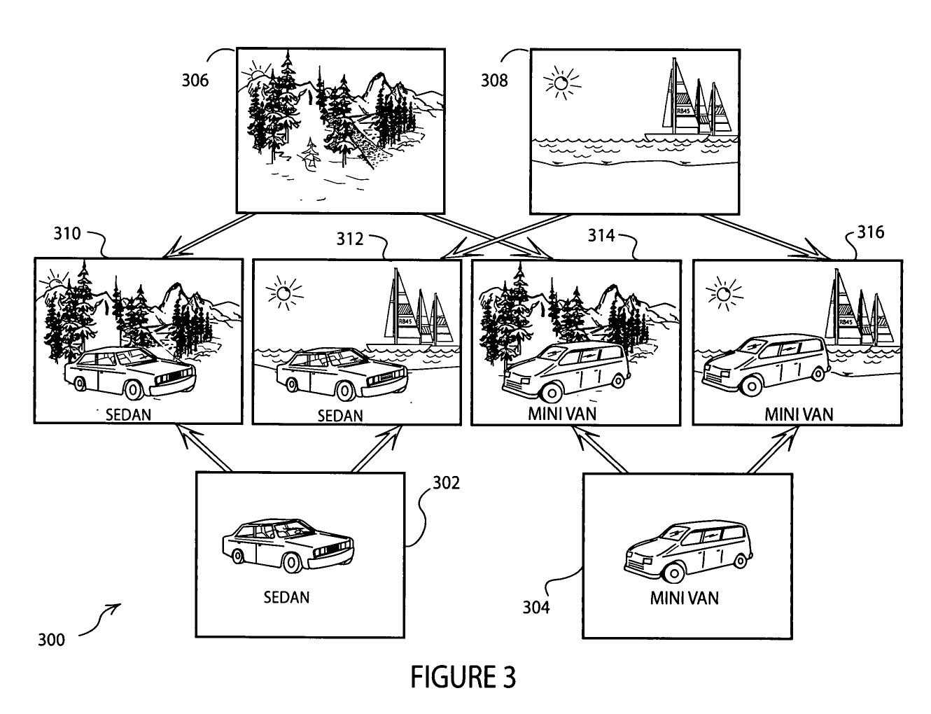

FIG. 3 illustrates an embodiment 300 of the present invention wherein four video signals, 302, 304, 306, and 308, may be combined into four composite video signals 310, 312, 314, and 316. The video signals 302 and 304 represent advertisements for two different vehicles. Video signal 302 shows an advertisement for a sedan model car, where video signal 304 shows an advertisement for a minivan. The video signals 306 and 308 are background images, where video signal 306 shows a background for a mountain scene and video signal 308 shows a background for an ocean scene. The combination or composite of video signals 306 and 302 yields signal 310, showing the sedan in front of a mountain scene. Similarly, the signals 312, 314, and 316 are composite video signals.

In the present embodiment, the selection of which composite image to display on a viewer's television may be made in part with a local preference for the viewer and by the advertiser. For example, the advertiser may wish to show a mountain scene to those viewers fortunate enough to live in the mountain states. The local preferences may dictate which car advertisement is selected. In the example, the local preferences may determine that the viewer is an elderly couple with no children at home and thus may prefer to see an advertisement for a sedan rather than a minivan.

The methodology for combining the various video streams in the present embodiment may be color key replacement. Color key replacement is a method of selecting pixels that have a specific color and location and replacing those pixels with the pixels of the same location from another video image. Color key replacement is a common technique used in the industry for merging two video images.

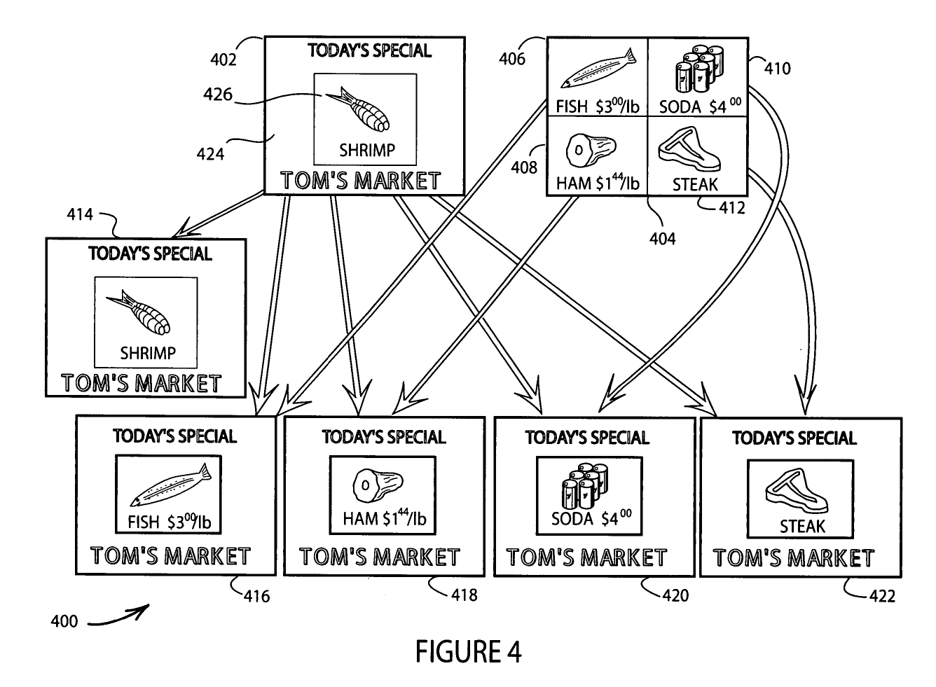

FIG. 4 illustrates an embodiment 400 of the present invention wherein a main video image 402 is combined with portions of a second video image 404. The second video image 404 comprises four small video images 406, 408, 410, and 412. The small images may be inserted into the main video image 402 to produce several composite video images 414, 416, 418, 420, and 422.

In the embodiment 400, the main video image 402 comprises a border 424 and a center advertisement 426. In this case, the border describes today's special for Tom's Market. The special is the center advertisement 426, which is shrimp. Other special items are shown in the second video image 404, such as fish 406, ham 408, soda 410, and steak 412. The viewer preferences may dictate which composite video is shown to a specific viewer. For example, if the viewer were vegetarian, neither the ham 408 nor steak 412 advertisements would be appropriate. If the person had a religious preference that indicated that they would eat fish on a specific day of the week, for example, the fish special 406 may be offered. If the viewer's preferences indicated that the viewer had purchased soda from the advertised store in the past, the soda advertisement 410 may be shown. In cases where no preference is shown, a random selection may be made by the set top box, a default advertisement, or other method for selecting an advertisement may be used.

Hence, the present invention provides a system in which a correlated or composite video signal can be generated at the viewer location. An advantage of such a system is that multiple video feeds can be provided and combined as desired at the viewer's location. This eliminates the need for generating separate combined video signals at a production level and transmission of those separate combined video signals over a transmission link. For example, if ten separate video feeds are provided over the transmission link, a total of ten factorial combined signals can be generated at the viewer's locations. This greatly reduces the number of signals that have to be transmitted over the transmission link.

Further, the present invention provides for interactivity in both an automated, semi-automated, and manual manner by providing interactive video feeds to the viewer location. As such, greater flexibility can be provided for generating a correlated video signal.

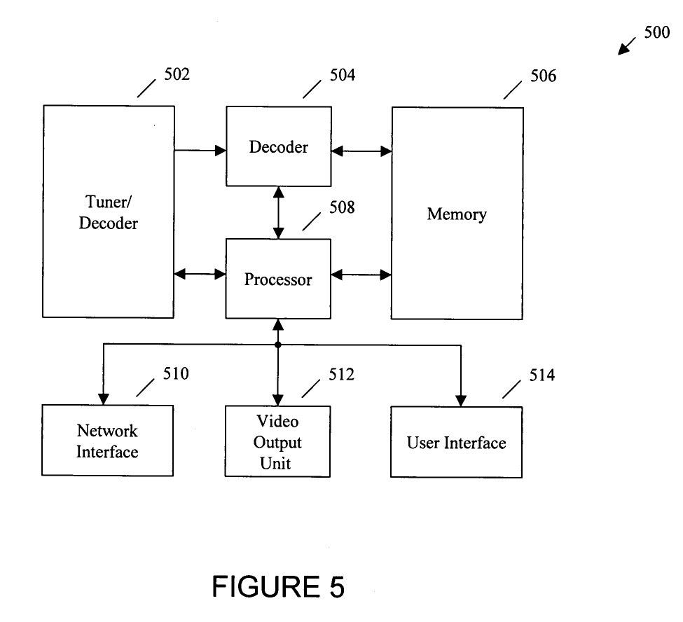

FIG. 5 depicts another set top box embodiment of the present invention. Set top box 500 comprises tuner/decoder 502, decoder 504, memory 506, processor 508, optional network interface 510, video output unit 512, and user interface 514. Tuner/decoder 502 receives a broadcast that comprises at least two video signals. In one embodiment of FIG. 5, tuner/decoder 502 is capable of tuning at least two independent frequencies. In another embodiment of FIG. 5, tuner/decoder 502 decodes at least two video signals contained within a broadcast band, as may occur with QAM or QPSK transmission over analog television channel bands or satellite bands. “Tuning” of video signals may comprise identifying packets with predetermined PID (Packet Identifiers) values or a range thereof and forwarding such packets to processor 508 or to decoder 504. For example, data packets may be transferred to decoder 504 and control packets may be transferred to processor 508. Data packets may be discerned from control packets through secondary PIDs or through PID values in a predetermined range. Decoder 504 processes packets received from tuner/decoder 502 and generates and stores image and/or audio information in memory 506. Image and audio information may comprise various information types common to DCT based image compression methods, such as MPEG and motion JPEG, for example, or common to other compression methods such as wavelets and the like. Audio information may conform to MPEG or other formats such as those developed by Dolby Laboratories and THX as are common to theaters and home entertainment systems. Decoder 504 may comprise one or more decoder chips to provide sufficient processing capability to process two or more video streams substantially simultaneously. Control packets provided to processor 508 may include presentation description information. Presentation description information may also be accessed employing network interface 510. Network interface 510 may comprise any type of network that provides access to a presentation description including modems, cable modems, DSL modems, upstream channels in a set top box and the like. Network interface 510 may also be employed to provide user responses to interactive content to a an associated server or other equipment. Processor 508 employs the presentation description to control combination of the image and/or audio information stored in memory 506. Combination may employ processor 508, decoder 504, or a combination of processor 508 and decoder 504. Combined image and or audio information, as created employing the presentation description, is supplied to video output unit 512 that produces and output signal for a television, monitor, or other type of display. The output signal may comprise composite video, S-video, RGB, or any other format. User interface 514 supports a remote control, mouse, keyboard or other input device. User input may serve to select versions of a presentation description or to modify a presentation description.

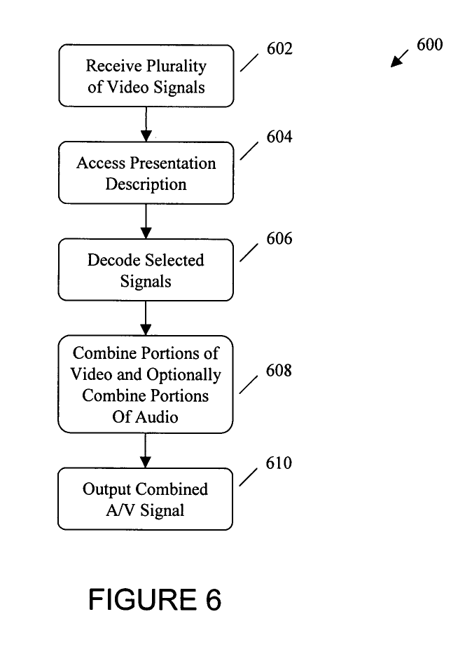

FIG. 6 depicts a sequence of steps 600 employed to create a combined image at a user's set top box. At step 602 a plurality of video signals are received. These signals may contain digitally encoded image and audio data. At step 604 a presentation description is accessed. The presentation description may be part of a broadcast signal, or may be accessed across a network. At step 606, at least two of the video signals are decoded and image data and audio data (if present) for each video signal is stored in a memory of the set top box. At step 608, portions of the video images and optionally portions of the audio data are combined in accordance with the presentation description. The combination of video images and optionally audio data may produce combined data in the memory f the set top box, or such combination may be performed “on the fly” wherein real-time combination is performed and the output provided to step 610. For example, if a mask is employed to select between portions of two images, non-sequential addressing of the set top box memory may be employed to access portions of each image in a real-time manner, eliminating the need to create a final display image in set top box memory. At step 610 the combined image and optionally combined audio are output to a presentation device such as a television, monitor, or other display device. Audio may be provided to the presentation device or to an amplifier, stereo system, or other audio equipment.

The presentation description of the present invention provides a description through which the method and manner in which images and/or audio streams are combined may be easily be defined and controlled. The presentation description may specify the images to be combined, the scene locations at which images are combined, the type of operation or operations to be performed to combine the images, and the start and duration of display of combined images. Further, the presentation description may include dynamic variables that control aspects of display such as movement, gradually changing perspective, and similar temporal or frame varying processes that provide image modification that corresponds to changes in scenes to which the image is applied.

Images to be combined may be processed prior to transmission or may be processed at a set top box prior to display or both. For example, an image that combined with a scene as the scene is panned may be clipped to render the portion corresponding to the displayed image such that a single image may be employed for a plurality of video frames.

The combination of video images may comprise replacing and/or combining a portion of a first video image with a second video image. The manner in which images are combined may employ any hardware or software methods and may include bit-BLTs (bit block logic transfers), raster-ops, and any other logical or mathematical operations including but not limited to maxima, minima, averages, gradients, and the like. Such methods may also include determining an intensity or color of an area of a first image and applying the intensity or color to an area of a second image. A color or set of colors may be used to specify which pixels of a first image are to be replaced by or to be combined with a portion of a second image. The presentation description may also comprise a mask that defines which areas of the first image are to be combined with or replaced by a second image. The mask may be a single bit per pixel, as may be used to specify replacement, or may comprise more than one bit per pixel wherein the plurality of bits for each pixel may specify the manner in which the images are combined, such as mix level or intensity, for example. The mask may be implemented as part of a markup language page, such as HTML or XML, for example. Any of the processing methods disclosed herein may further include processes that produce blurs to match focus or motion blur. Processing methods may also include processes to match “graininess” of a first image. As mentioned above, images are not constrained in format type and are not limited in methods of combination.

The combination of video signals may employ program code that is loaded into a set top box and that serves to process or interpret a presentation description and that may provide processing routines used to combine images and/or audio in a manner described by the presentation description. This program code may be termed image combination code and may include executable code to support any of the aforementioned methods of combination. Image combination code may be specific to each type of set top box.

The combination of video signals may also comprise the combination of associated audio streams and may include mixing or replacement of audio. For example, an ocean background scene may include sounds such as birds and surf crashing. As with video images, audio may be selected in response to viewer demographics or preferences. The presentation description may specify a mix level that varies in time or across a plurality of frames. Mixing of audio may also comprise processing audio signals to provide multi-channel audio such as surround sound or other encoded formats.

Embodiments of the present invention may be employed to add content to existing video programs. The added content may take the form of additional description, humorous audio, text, or graphics, statistics, trivia, and the like. As previously disclosed, a video feed may be an interactive feed such that the viewer may response to displayed images or sounds. Methods for rendering and receiving responses to interactive elements may employ any methods and includes those disclosed in incorporated applications. Methods employed may also include those disclosed in U.S. continuation-in-part application Ser. No. 10/403,317 filed Mar. 27, 2003 by Thomas Lemmons entitled “Post Production Visual Enhancement Rendering”, and in the parent application, U.S. non-provisional patent application Ser. No. 10/212,289 filed Aug. 8, 2002 by Thomas Lemmons entitled “Post Production Visual Alterations”, and in the associated U.S. provisional patent application serial No. 60/309,714 filed Aug. 8, 2001 by Thomas Lemmons entitled “Post Production Visual Alterations”, all of which are specifically incorporated herein for all that they teach and disclose. As such, an interactive video feed that includes interactive content comprising a hotspot, button, or other interactive element, may be combined with another video feed and displayed, and a user response the interactive area may be received and may be transferred over the Internet, upstream connection, or other network to an associated server.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of producing a video signal at a set top box comprising:
receiving a first video signal at said set top box;
processing said first video signal to produce a first image stored in memory of said set top box;
receiving a second video signal at said set top box;
processing said second video signal to produce a second image stored in said memory of said set top box;
accessing a presentation description that defines a portion of said first image and that defines the manner in which said portion of said first image and a portion of said second image are combined;
combining said portion of said first image with said portion of second image in accordance with said presentation description to produce a combined image; and
displaying said combined image.

2. The method of claim 1 wherein said step of combining further comprises:
applying a mask that defines said portion of said first image.

3. The method of claim 1 wherein said step of combining said video signals further comprises:
generating a logical combination of said portion of said first image and said portion of said second image.

4. The method of claim 1 wherein said step of combining said video signals further comprises:
generating a mathematical combination of said portion of said first image and said portion of said second image.

5. The method of claim 1 wherein said step of combining said video signals further comprises:
scaling said portion of said first image.

6. The method of claim 1 wherein said step of combining said video signals further comprises:
warping said portion of said first image.

7. The method of claim 1 wherein said step of accessing said presentation description further comprises:
accessing said presentation description across a network.

8. The method of claim 1 wherein said step of accessing said presentation description further comprises:
receiving a network address at which a presentation description can be accessed.

9. The method of claim 1 wherein said step of accessing said presentation description further comprises:
selecting said presentation description from a plurality of presentation descriptions contained in said first video signal.

10. The method of claim 1 further comprising:
modifying said presentation description in response to a user input.

11. The method of claim 1 further comprising:
processing said first video signal to produce first audio data stored in said memory of said set top box;
processing said second video signal to produce second audio data stored in said memory of said set top box;
accessing a presentation description that describes the manner in which said first audio data and said second audio data are combined; and
combining said first audio data and said second audio data in accordance with said presentation description.

12. A method of displaying a sequence of combined images in a set top box comprising:
receiving a first video signal at said set top box;
processing said first video signal to produce a first sequence of images stored in memory of said set top box;
receiving a second video signal at said set top box;
processing said second video signal to produce a second sequence of images stored in said memory of said set top box;
accessing a presentation description that defines a portion of said first sequence of images and that defines the manner in which said portion of said first sequence of images and a portion of said second sequence of images are combined;
combining said portion of said first sequence of images with said portion of said second sequence of images in accordance with said presentation description to produce a sequence of combined images; and
displaying said sequence of combined images.

13. The method of claim 12 wherein said step of combining further comprises:
applying a mask specified in said presentation description that defines said portion of said first sequence of images.

14. The method of claim 13 wherein said step of applying a mask further comprises:
executing program code that modifies said mask to select a different portion of at least one image of said first sequence of images.

15. The method of claim 12 wherein said step of combining said video signals further comprises:
generating a mathematical combination of said portion of one image of said first sequence of images and said portion of one image of said second sequence of images.

16. The method of claim 12 wherein said step of combining said video signals further comprises:
generating a logical combination of said portion of one image of said first sequence of images and said portion of one image of said second sequence of images.

17. The method of claim 12 wherein said step of combining said video signals further comprises:
scaling said portion of one image of said first sequence of images.

18. The method of claim 12 wherein said step of combining said video signals further comprises:
warping said portion of one image of said first sequence of images.

19. The method of claim 12 further comprising:
modifying said presentation description in response to a user input.

20. A method of controlling generation of a combined video signal in a set top box unit at a user's premises from a broadcast site comprising:
transmitting a first digital video signal to said set top box;
transmitting a second digital video signal to said set top box substantially simultaneously with said first digital video signal;
loading image combination code into said set top box; and
providing a presentation description to said set top box that describes the manner in which a portion of an image contained in said first digital video signal is combined with a portion of an image contained in said second digital video signal to produce said combined video signal.

21. The method of claim 20 wherein said step of providing a presentation description further comprises:
transmitting a network address that said set top box employs to access said presentation description.

22. The method of claim 20 wherein said step of providing a presentation description further comprises:
transmitting said presentation description to said set top box as a part of said first digital video signal.

23. The method of claim 20 wherein said step of providing a presentation description further comprises:
selecting said presentation description from a plurality of presentation descriptions wherein said presentation description conforms to the requirements of said set top box.

24. The method of claim 20 wherein said step of providing a presentation description further comprises:
altering a general presentation description to conform to the requirements of said set top box.

25. The method of claim 20 wherein said step of providing a presentation description further comprises:
tailoring a general presentation description to correspond to a viewer preference.

26. The method of claim 20 wherein said step of providing a presentation description further comprises:
transmitting a plurality of presentation descriptions to said set top box from which said set top box selects one presentation description that conforms to the requirements of said set top box.

27. A set top box that produces a combined video signal comprising:
a processor;
a memory;
a tuner/decoder that receives a first video signal and a second video signal substantially simultaneously and that routes control information contained in said first video signal to said processor and that routes first video data from said first video signal and second video data from said second video signal to a decoder;
said decoder that decodes said first video data and produces a first video image in said memory and that decodes said second video data and produces a second video image in said memory;
a presentation description stored in said memory that specifies the manner in which a portion of said first video image is combined with a portion of said second video image to produce said combined signal;
program code operating in said processor that employs said presentation description and that accesses said portion of said first video image and said portion of said second video image in said memory and that combines said first portion of said first video image and said portion of said second video image in a manner specified by said presentation description; and
a video output unit that outputs said combined signal to a display device.

28. The system of claim 27 further comprising:
a network interface that accesses a presentation description.

29. The system of claim 27 wherein said decoder further produces first audio data in said memory from said first video information and produces second audio data in said memory from said second video information.

30. The system of claim 29 wherein said presentation description further specifies the manner in which said first audio data is combined with said second audio data.

31. The system of claim 27 further comprising:
a user interface that receives an input from a user that modifies said presentation description.

32. The system of claim 27 further comprising:
user preference information stored in said memory that is used by said presentation description.

33. The system of claim 27 wherein said program code operating in said processor further comprises:
a software routine that controls said decoder to perform at least part of the combination of said portion of said first video image and said portion of said second video image in a manner specified by said presentation description.

34. The system of claim 27 wherein said program code operating in said processor further comprises:
a software routine that selects said presentation from a plurality of presentation descriptions contained in said first video signal.

35. A set top box that produces a combined video signal comprising:
processor means that process a presentation description and that control the manner in which images are combined;
memory means that store software executable by said processor means and that store video images;
tuner/decoder means that receive a first video signal and a second video signal and that route control information contained in said first video signal to said processor means and that route first video information from said first video signal and second video information from said second video signal to decoder means;
decoder means that decode said first video information and produce a first video image in said memory means and that decode said second video information and produce a second video image in said memory means;
presentation description means that specify the manner in which a portion of said first video image is combined with a portion of said second video image to produce a combined image; and
video output means that output said combined image to a display device.
